(19) United States
(12) Patent Application Publication
(10) Pub. No.: US 2004/0100711 A1
(43) Pub. Date: May 27, 2004

(54) Magnetic recording medium provided with track ID information, magnetic recording device, and method thereof

(76) Inventors: Narumi Sato, Nagano (JP); Kiminori Sato, Nagano (JP)

Correspondence Address: ROSSI & ASSOCIATES, P.O. Box 826, Ashburn, VA, 20146-0826, US

(21) Appl. No.: 10/621,039

(22) Filed: Jul. 16, 2003

(30) Foreign Application Priority Data
Jul. 17, 2002 (JP) 2002-207698

(51) Int. Cl. G11B 5/09; G11B 19/04; G11B 5/86

(52) U.S. Cl. 360/48; 360/60; 360/15

(57) ABSTRACT

Security of contents data can be enhanced by providing ID information in each of the recording tracks. The ID information can be made tamper proof by burying the ID information that is difficult to be rewritten in a substrate itself of a magnetic recording medium. This protect contents data from copyright piracy, such as unauthorized copying and tampering of the contents by relating contents data to be recorded to the buried ID information. The track ID information can be buried in each of the recording tracks with a pattern of pits formed in a non-magnetic substrate. When reading the contents data recorded in the recording track, the track ID information of the recording track is read out together with the contents data.

### BACKGROUND

Advancement of the Internet, technological progress, and wide spread use of mass hard disk drives are meeting the conditions for distributing digital contents via networks. Moreover, application of the mass hard disk drive for receiving television broadcasting is being considered. Thus, “server broadcasting” contemplates broadcasting or communicating about one week's worth of information contents to each of one or more storage receivers introduced in each home for enabling the user to watch desired contents at any desired time.

A significant emphasis is placed on preventing copyright piracy, which includes unauthorized copying, license tampering, or the like, while providing the consumers with digital data with no degradation in video quality and that are easy to duplicate for authorized users. To this end, a unique copyright code (contents ID) to each of digital contents is being contemplated. This specifically gives each set of the contents an item of copy control information, an item of information of term of permission for watching, writing, and reading attribute and the like. These features, however, are software based, which makes it prone to unauthorized use, such as by cracking, and thus not completely free from being tamper proof.

Accordingly, there is a need for a magnetic recording medium and a magnetic recording device that can enhance security to allow copyright management possible. The present invention addresses this need.

### SUMMARY OF THE INVENTION

The present invention relates to a magnetic recording medium provided with track ID information on each of recording tracks and a magnetic recording device, which are particularly suited for preventing unauthorized use.

One aspect of the present invention is a magnetic recording medium composed of a substrate with a magnetic recording layer. The substrate has a plurality of recording tracks each with track ID information that is not erasable with a magnetic recording head used for writing contents data to the magnetic recording medium.

The track ID information can be buried in each of the recording tracks, each of which has a pattern of pits formed on the substrate. This makes it difficult to rewrite the item of track ID information. The signal arrangement of the track ID information formed by the pattern of pits can be randomly set at each of the recording tracks without any relevance and regularity that depends on a position of the track. This can prevent signal logic of a track ID section in data read in from the magnetic head from being rewritten in an unauthorized way.

Another aspect of the present invention is a magnetic recording device that includes the above magnetic recording medium and a magnetic recording head. The magnetic recording head reads contents data recorded in the recording track with the track ID information, along with the track ID information thereof.

Another aspect of the present invention is a method of enhancing data security for contents data writable to the above magnetic recording medium. The method includes forming a unique track ID information that is not erasable with a magnetic recording head used for writing contents data to the magnetic recording medium on each of the recording tracks, writing content data on the recording medium between the track ID information, reading the contents data recorded in the recording track with the track ID information, along with the track ID information thereof, and authenticating the contents data by relating the read track ID information to the contents data.

### BRIEF DESCRIPTION OF THE DRAWINGS

FIG. 1 schematically illustrates an arrangement of recording tracks in a partial plan view of a magnetic recording medium according to the present invention.

FIGS. 2A-2D schematically illustrate the process of burying a track ID in the magnetic recording medium with a pattern of pits or recesses.

FIG. 3 schematically illustrates data format written to the recording medium with the track IDs buried with patterns of pits.

FIG. 4 schematically illustrates data being copied from the recording medium with the track IDs buried with the patterns of pits.

FIG. 5 schematically illustrates encrypted data being copied from the recording medium with the track IDs buried with the patterns of pits.

### DETAILED DESCRIPTION

The present invention make it possible to enhance security by providing ID information in each of the recording tracks, and burying such ID information so that it is difficult to write over them. This makes it possible to protect contents data from copyright piracy, such as unauthorized copying and tampering thereof by relating the contents data to be recorded to the buried item of ID information. For instance, a different pattern of pits can be physically engraved in each of recording tracks to form a track ID information. By depositing a magnetic layer on the substrate with the pattern, the magnetic recording medium buried with the track ID information can be formed. With the surface of the magnetic recording medium magnetized, the track ID information can be read with a magnetic head.

The track ID information can be randomly set without any relevance and regularity to the positions of the tracks. This is for preventing signal logic of a track ID section in data from being broken and rewritten in an unauthorized way when reading the data read in from the magnetic head. Moreover, the number of track IDs per track can be arbitrary. Nevertheless, a plurality of the track IDs can be also provided for enhancing security characteristics. The number is desirably determined considering the amount of reduction in data recording sections (data zones) in the magnetic recording medium; burying the track ID information reduces the recordable surface area.

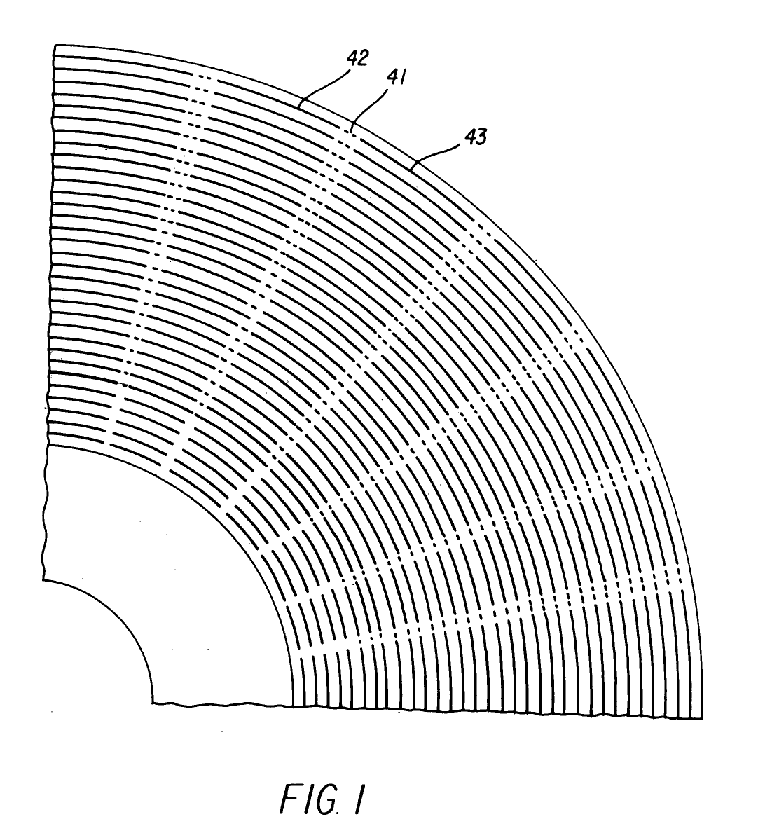

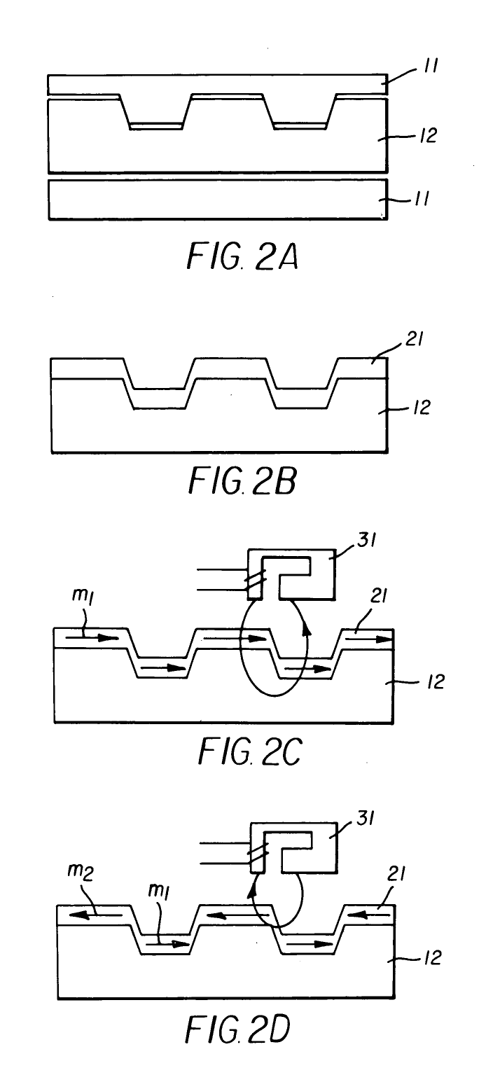

FIG. 1 is a partial plan view of a magnetic recording medium (a magnetic disk), schematically showing an arrangement of recording tracks, with reference numeral 41 denoting a track ID, 42 denoting an item of servo information and 43 denoting a data zone. Here, the track ID 41 (and the item of servo information 42) are buried in the surface of the magnetic recording medium by forming patterns of pits, a process of formation of which is shown in FIGS. 2A-2D, and also disclosed in co-pending application identified by FUJI:262, filed Jul. 15, 2003, the disclosed of which is incorporated herein by reference.

As shown in FIG. 2A, the pits in the magnetic recording medium can be formed with a mold (stamper) 11 preformed with projections (a pattern corresponding to the track ID 41), and molding a non-magnetic substrate 12 using the stamper 11 to transfer the pattern of the projections of the stamper 11 onto the substrate 12 as a desired pattern of pits. As shown in FIG. 2B, a magnetic layer 21 is deposited on the substrate 12, and then magnetized as shown in FIGS. 2C and 2D to produce a signal waveform corresponding to the pattern of the pits of the track ID 41.

A method of producing signals using pits formed in the surface of a magnetic recording medium is also described in each of JP-A-6-68444 and JP-A-7-153047 as a method of pre-forming the position identification information (servo information) 42 on a track. The information engraved on the surface of the magnetic recording medium makes it possible to obtain a reproduced output with the use of the two-step magnetizing method described in JP-A-2000-306236. Namely, as shown in FIG. 2C, a large current is first fed to a magnetic head 31 to strongly magnetize the head 31 to magnetize the entire face of the magnetic layer 21 (including both the main surface and the pits in direction mi. Then, as shown in FIG. 2D, with a weaker magnetization using a smaller current, only the surface portion is magnetized in direction m₂. That is, the direction of the applied current can be controlled to set forth the polarity of the magnetization that is opposite to the first magnetization. By the foregoing steps, a reproduced output can be made to correspond to the pattern of the pits. The data zone 43 is an ordinary flat surface without any pits.

It is difficult to rewrite the track ID 41 formed with the pattern of pits using the magnetic head 31 used in a magnetic recording device. Even though the surface portion of the track with the track ID 41 can be overwritten, by re-magnetizing with the magnetic head 31 prior to reading, the magnetic head 31 does not alter the magnetization formed at the pits, where the track ID information is formed.

When reading and writing are carried out with the above-explained magnetic recording medium mounted on a magnetic recording device (a hard disk drive), for shifting the magnetic head 31 onto a targeted track, the position identification information (servo information) 42 recorded on the track is first detected. The servo information 42 is for distinguishing the track position on the magnetic recording medium to judge an amount of positional error between the targeted track and the magnetic head 31. Therefore, the information should be allotted with regularity related to the position of the track. Moreover, the track ID 41 is a designation specific to each of the tracks. The track ID 41 does not function for following the position of the magnetic head 31, but is data read out as track identification information when the magnetic head 31 is following a targeted track.

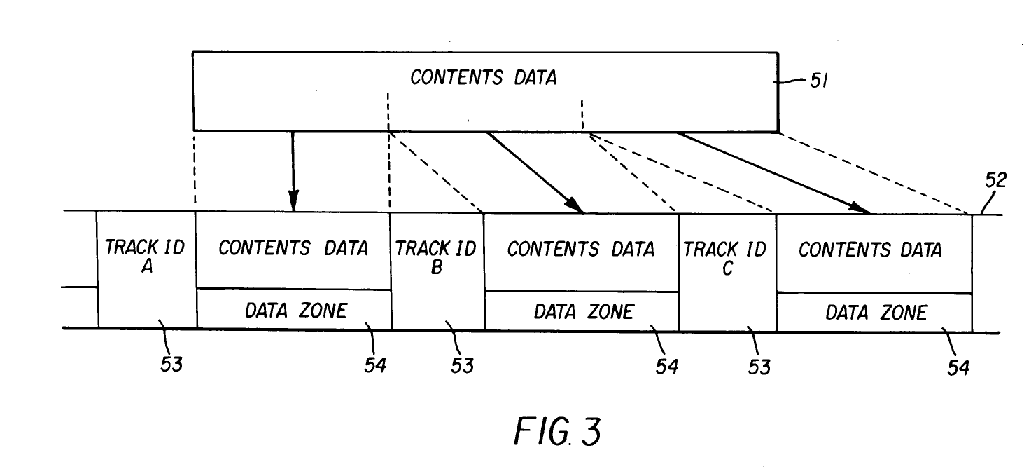

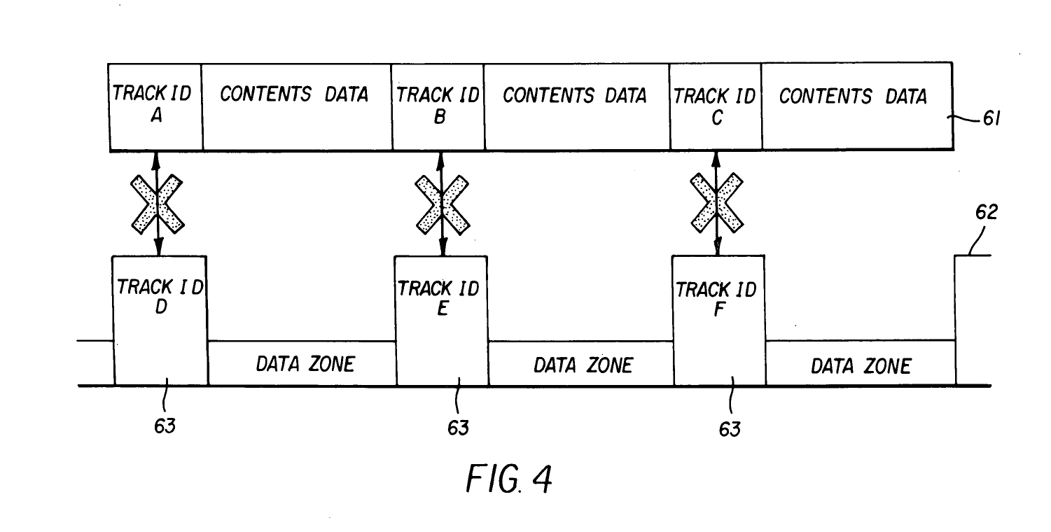

Furthermore, when the original contents data 51 are recorded in the magnetic recording medium, as shown in FIG. 3, track IDs 53, each formed with the pattern of pits, are inserted between or at midpoint of the original contents data 51. At this time, the original contents data 51 are recorded as unique contents data 52 with the track IDs 53, which are provided in the magnetic recording medium, added to the original contents data 5 1. When the magnetic head 31 reads the recorded contents data 52, in addition to the data recorded in data zones 54, the ID tracks 53 are also read together therewith. As a result, the user of the magnetic recording device having the magnetic recording media can only make use of the contents data 61 with the track IDs 53 (FIG. 4).

As shown in FIG. 4, when an attempt is made to copy the contents data 61, when no permission of copy is given, to another magnetic recording media 62, the track IDs 53 given to the original recording is contained in the contents data 61, providing no consistency with the track IDs 63 of a copy designation track to make the copy impossible. In this case, on the magnetic recording medium having track IDs 41 formed with the patterns of pits, ID information different in each medium (a media ID), and the information about the kind of the magnetic recording device on which the magnetic recording medium is mounted, and the information about the date of manufacture (media meta) are further formed with patterns of pits. This can increase items of the ID information given to the recorded contents data 52 to make tampering and unauthorized copy more difficult.

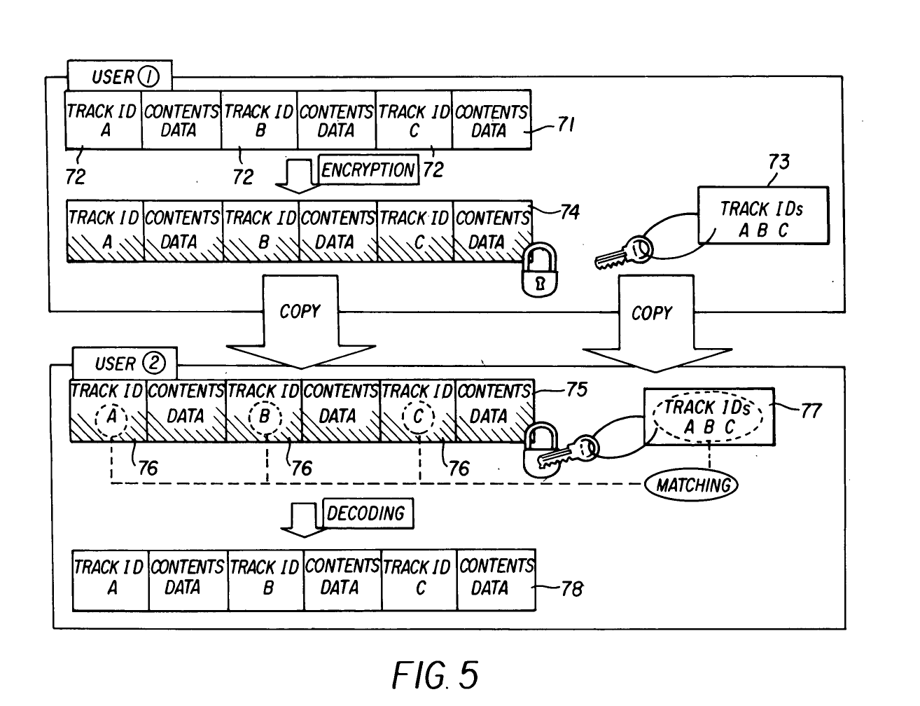

Moreover, as shown in FIG. 5, when the user takes a copy of contents data 71 recorded in the magnetic recording medium, track IDs 72 can be used as a key 73 for encrypting the contents data 71. The given track IDs 72 differ according to the recorded tracks, which are applied to providing meaning as a unique key 73 to encrypt the contents. When taking a copy, the encrypted contents data 74 and the key 73 provided by the track IDs 72 are duplicated. By a key 77 with copied track IDs, encrypted contents data 75 are decoded to form decoded data 78. At this time, with the key 77 with the track IDs matching track IDs 76 contained in the contents data 75, copied contents data can be authenticated.

The magnetic recording media can have track IDs 41, as well as media IDs, and items of media meta information, formed with patterns of pits. This can increase the ID information given to the recorded contents data 71. With these data used for generating a key, more complicated encryption becomes possible, such as encryption of the key 73 of track IDs with media IDs, for example.

According to the present invention, each of the recording tracks can be provided with track ID information. The track ID information can be related to the contents data to thereby enable strengthened security of the contents. Moreover, by burying the track ID information with a physical pattern of pits, the track ID information can be made difficult to tamper with. As the track ID information is related to the contents data, it enables more effective means of preventing copyright piracy, such as unauthorized copy of the contents and data tampering. Furthermore, when the recorded contents data are read, the recorded contents data are made read as contents data with the track ID information. This can relate the item of track ID information to the contents data to enable more secure protection of copyrighted data.

Given the disclosure of the present invention, one versed in the art would appreciate that there may be other embodiments and modifications within the scope and spirit of the present invention. Accordingly, all modifications and equivalents attainable by one versed in the art from the present disclosure within the scope and spirit of the present invention are to be included as further embodiments of the present invention. The scope of the present invention accordingly is to be defined as set forth in the appended claims.

The disclosure of the priority application, JP PA 2002-207698, in its entirety, including the drawings, claims, and the specification thereof, is incorporated herein by reference.

What is claimed is:

1. A magnetic recording medium comprising:
a substrate with a magnetic recording layer, the substrate having a plurality of recording tracks each with track ID information that is not erasable with a magnetic recording head used for writing contents data to the magnetic recording medium.

2. A magnetic recording medium according to claim 1, wherein the track ID information is buried in each of the recording tracks, each of which has a pattern of pits formed on the substrate.

3. A magnetic recording medium according to claim 2, wherein a signal arrangement of the track ID information formed by the pattern of pits is randomly set at each of the recording tracks without any relevance and regularity that depends on a position of the track.

4. A magnetic recording device including the magnetic recording medium according to claim 1, including a magnetic recording head, wherein the magnetic recording head reads contents data recorded in the recording track with the track ID information, along with the track ID information thereof.

5. A magnetic recording device including the magnetic recording medium according to claim 2, including a magnetic recording head, wherein the magnetic recording head reads contents data recorded in the recording track with the track ID information, along with the track ID information thereof.

6. A magnetic recording device including the magnetic recording medium according to claim 3, including a magnetic recording head, wherein the magnetic recording head reads contents data recorded in the recording track with the track ID information, along with the track ID information thereof.

7. A method of enhancing data security for contents data writable to a magnetic recording medium with a substrate with a magnetic recording layer, the substrate having a plurality of recording tracks, the method comprising the steps of:
forming a unique track ID information that is not erasable with a magnetic recording head used for writing contents data to the magnetic recording medium on each of the recording tracks;
writing content data on the recording medium between the track ID information;
reading the contents data recorded in the recording track with the track ID information, along with the track ID information thereof; and
authenticating the contents data by relating the read track ID information to the contents data.
